(19) United States
(12) Patent Application Publication
(10) Pub. No.: US 2005/0104873 A1
(43) Pub. Date: May 19, 2005

(54) Last frame repeat

(76) Inventors: Mallinath Hatti, Bangalore (IN); Lakshmanan Ramakrishnan, Bangalore (IN)

Correspondence Address: CHRISTOPHER C WINSLADE;MCANDREWS HELD & MALLOY LTD, 34TH FLOOR, 500 WEST MADISON STREET, CHICAGO, IL, 60661, US

(21) Appl. No.: 10/714,216

(22) Filed: Nov. 14, 2003

(51) Int. Cl. G09G 5/00

(52) U.S. Cl. 345/204

(57) ABSTRACT

Presented herein are systems and methods for repeating a last picture. A first frame is provided for display a first time. After displaying the first frame, the information about a second frame to display is awaited. The first frame is repeated if the information regarding the second frame is not received before a predetermined time.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

A display device usually receives video frames from another device that is attached to, but was manufactured separately from the display device. The device providing the frames and the display device are synchronized by means of a vertical synchronization pulses Vsynch and horizontal synchronization pulses Hsynch. The display device signifies the beginning of a time period for the display of a frame by transmitting a vertical synchronization pulse (Vsynch).

Between the vertical synchronization pulse and the first horizontal synchronization pulse, there is a period of time known as the vertical blanking interval VBI. During the VBI, preparations are made for displaying the next frame. The preparation can include receiving information regarding the next frame for display and an address in a buffer storing the first pixel of the next frame for display.

Ideally, the foregoing information is received before or during the VBI. However, if the foregoing is not received, the device providing the frames may not be able to provide the next frame for display. The foregoing can potentially result in a noticeable degradation of quality in the display of the video.

Further limitations and disadvantages of conventional and traditional approaches will become apparent to one of skill in the art, through comparison of such systems with embodiments presented in the remainder of the present application with references to the drawings.

### BRIEF SUMMARY OF THE INVENTION

Described herein is a system and method for repeating a last frame.

In one embodiment, there is presented a method for displaying frames. The method comprises providing a first frame, waiting to receive information about a second frame to display, after displaying the first frame, and providing the first frame, if the information regarding the second frame is not received before a predetermined time.

In another embodiment, there is presented a system for displaying frames. The system comprises a display engine, and a host processor. The display engine provides a first frame. The host processor provides information about a second frame to the display engine, after the display engine provides the first frame. The display engine provides the first frame, if the host processor does not provide the information regarding the second frame to the display engine before a predetermined time.

In another embodiment, there is presented a feeder for providing a frame. The feeder comprises a first one or more registers, a circuit, and a host processor. The first one or more registers stores one or more starting address for a first frame. The circuit calculates starting addresses for one or more rows of the first frame following a vertical synchronization pulse associated with the first frame. The host processor writes one or more starting address for a second frame to the first one or more registers. The first one or more registers stores the one or more starting address for the first frame until the host processor writes the one or more starting address for the second frame to the first one or more registers.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram describing an exemplary display timing diagram;

FIG. 2 is a flow chart for displaying a frame in accordance with an embodiment of the present invention;

FIG. 3 is a block diagram of a decoder system in accordance with an embodiment of the present invention;

FIG. 4 is a block diagram of a display engine in accordance with an embodiment of the present invention; and

FIG. 5 is a block diagram of an exemplary feeder in accordance with an embodiment of the present invention.

### DETAILED DESCRIPTION OF THE INVENTION

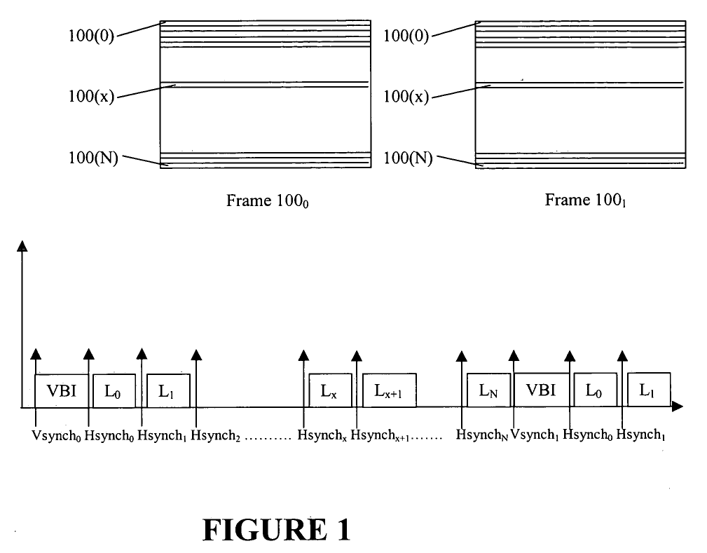

Referring now to FIG. 1, there is illustrated a block diagram describing a display timing diagram. Video data comprises a series of consecutive frames 100. Each frame 100 is associated with a particular time interval. A display device displays the frames at the specific predetermined time with highly synchronized timing.

The frames 100 further comprise any number of lines 0 . . . N of pixels. The display device displays the lines 0 . . . N at a particular time interval within the time interval for displaying the frame. In the case of a progressive display, the lines 0 . . . N are displayed in consecutive order, line 0, line 1, line 2, . . . line N.

The display device usually receives the frames from another device that is attached to, but was manufactured separately from the display device. The device providing the frames and the display device are synchronized by means of a vertical synchronization pulses Vsynch and horizontal synchronization pulses Hsynch. The display device signifies the beginning of a time period for the display of a frame by transmitting a vertical synchronization pulse (Vsynch). The display device signifies the time period for displaying a new line in a frame 100 (x) by transmitting a horizontal synchronization pulse Hsynch. The device providing the frames uses the foregoing vertical/horizontal synchronization pulses to follow the timing of the display device, and provides the appropriate line 100 (x) of the appropriate frame 100 for display at the appropriate time.

For a progressive display, each vertical synchronization pulse Vsynch is followed by horizontal synchronization pulses Hsynch₀, Hsynch₁, Hsynch₂ , . . . Hsynch_{N}, associated with each line 100(0), 100(1), 100(2), . . . 100(N) in the frame 100. Responsive to the horizontal synchronization pulses Hsynchₓ, the display device receives and displays the horizontal line 100(x) associated with the horizontal synchronization pulse.

Between each consecutive Hsynch, there is a time period to allow for preparation to display the next line. The preparations can include, for example, determining a memory address in a buffer that stores the pixels of the next line.

Additionally, between the vertical synchronization pulse Vsynch and the first horizontal synchronization pulse Hsynch₀, there is a period of time known as the vertical blanking interval VBI. During the VBI preparations are made for displaying the next frame. The preparation can include receiving information regarding the next frame for display and an address in a buffer storing the first pixel of the next frame for display.

Ideally, the foregoing information is received before or during the VBI. However, if the foregoing is not received, the device providing the frames may not be able to provide the next frame for display. The foregoing can potentially result in a noticeable degradation of quality in the display of the video. To reduce the degradation in the quality of the display of the video caused by the foregoing, where the device does not receive the information regarding the next frame, e.g., 100₁ for display by a predetermined time, such as the first Hsynch₀ following Vsynch₁, the device provides the previous frame 100₀ for display during the display time (the time period between Vsynch₁ and the following Vsynch) for frame 100₁.

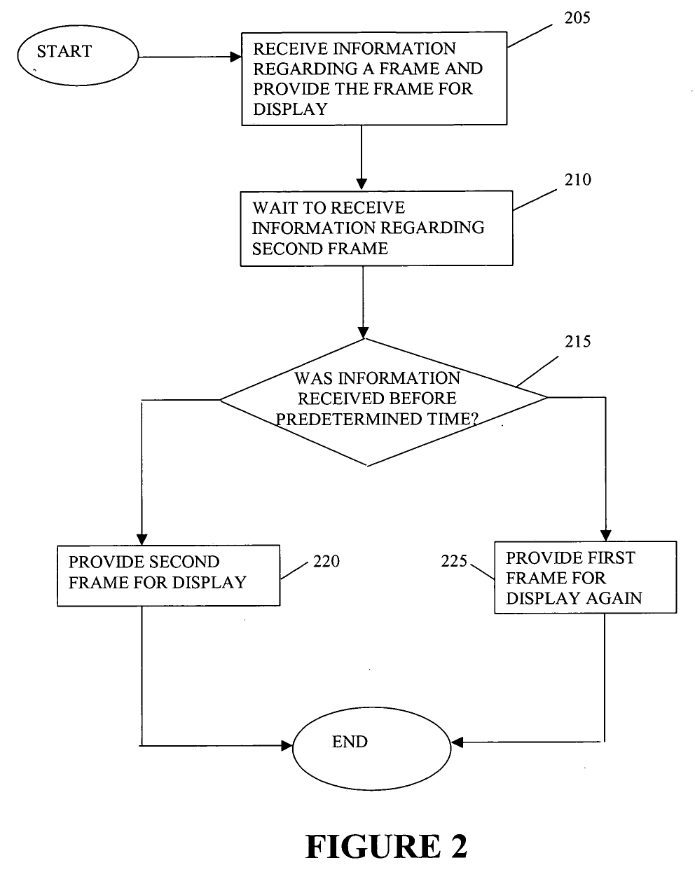

Referring now to FIG. 2, there is illustrated a flow diagram for displaying frames in accordance with an embodiment of the present invention. At 205, the device for providing frames for display to the display device receives information regarding the first frame for display and provides the first frame for display. After providing the first frame for display, the device waits (210) to receive information regarding the next frame for display. At 215, if the device receives the information before the predetermined time, the device provides (220) the next frame for display. If at 215, the device does not receive the information before the predetermined time, the device provides (225) the frame provided during 205 for display again.

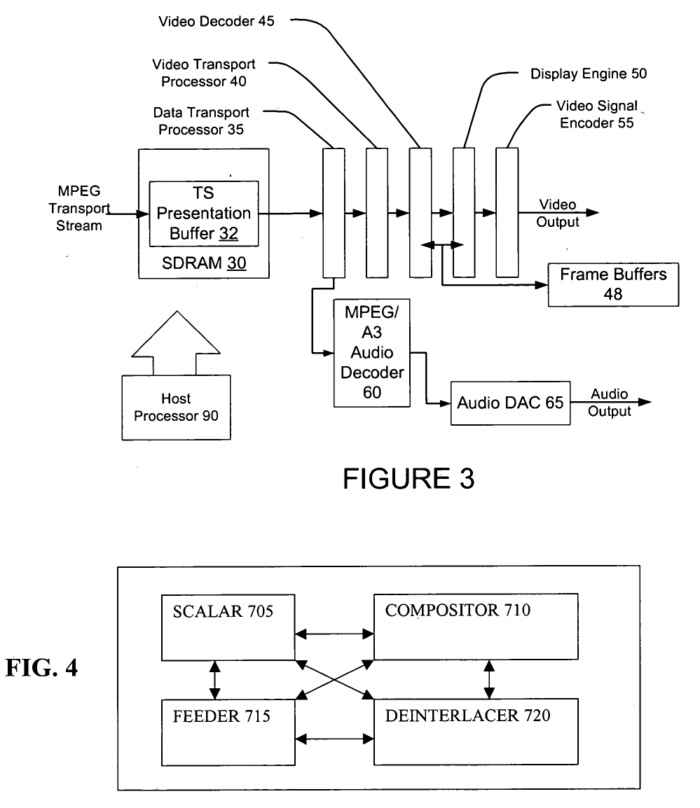

Referring now to FIG. 3, there is illustrated a block diagram describing an exemplary decoder system for providing frames for display to a display device in accordance with an embodiment of the present invention. A processor, that may include a CPU 90, reads transport bitstream 65 into a transport bitstream buffer 32 within an SDRAM 30.

The data is output from the transport bitstream buffer 32 and is then passed to a data transport processor 35. The data transport processor 35 then demultiplexes the transport bitstream 65 into constituent transport bitstreams. The constituent packetized elementary bitstream can include for example, video transport bitstreams, and audio transport bitstreams. The data transport processor 35 passes an audio transport bitstream to an audio decoder 60 and a video transport bitstream to a video transport processor 40.

The video transport processor 40 converts the video transport bitstream into a video elementary bitstream and provides the video elementary bitstream to a video decoder 45. The video decoder 45 decodes the video elementary bitstream, resulting in a sequence of decoded video frames. The decoding can include decompressing the video elementary bitstream. The decoded video data includes a series of frames. The frames are stored in a frame buffer 48.

The display engine 50 is responsible for providing a bitstream to a display device, such as a monitor or a television. The display device and the decoder system are synchronized by horizontal and vertical synchronization pulses. Between the vertical synchronization pulse Vsynch and the first horizontal synchronization pulse Hsynch₀, there is a period of time known as the vertical blanking interval VBI. During the VBI, preparations are made for displaying the next frame. The preparation can include the host processor 90 determining the frame for display and providing an address in the frame buffer storing the first pixel of the frame for display to the display engine 50.

Ideally, the display engine 50 receives foregoing information before or during the VBI. However, if the foregoing is not received, the display engine 50 may not be able to provide the next frame, frame 100₁, for display. The foregoing can potentially result in a noticeable degradation of quality in the display of the video. To reduce the degradation in the quality of the display of the video caused by the foregoing, where the display engine 50 does not receive the information regarding the next frame, e.g., 100₁ for display by a predetermined time, such as the first Hsynch₀ following Vsynch₁, the display engine 50 provides the previous frame 100₀ for display during the display time (the time period between Vsynch₁ and the following Vsynch) for frame 100₁.

Referring now to FIG. 4, there is illustrated a block diagram of the display engine 50 in accordance with an embodiment of the present invention. The display engine 50 includes a scalar 705, a compositor 710, a feeder 715, and a deinterlacing filter 720. The feeder 715 rasterizes the pixels of the displayed frame.

The feeder 715 and the display device are synchronized by horizontal and vertical synchronization pulses. During the VBI, preparations are made for displaying the next frame. The preparations can include the host processor 90 determining the frame for display and providing an address in the frame buffer storing the first pixel of the frame for display to the feeder 715.

Ideally, the feeder 715 receives foregoing information before or during the VBI. However, if the foregoing is not received, the feeder 715 may not be able to rasterize and provide the next frame, frame 100₁, for display. The foregoing can potentially result in a noticeable degradation of quality in the display of the video. To reduce the degradation in the quality of the display of the video caused by the foregoing, where the pixel feeder 715 does not receive the information regarding the next frame, e.g., 100₁ for display by a predetermined time, such as the first Hsynch₀ following Vsynch₁, the pixel feeder 715 rasterizes and provides the previous frame 100₀ for display during the display time (the time period between Vsynch₁ and the following Vsynch) for frame 100₁.

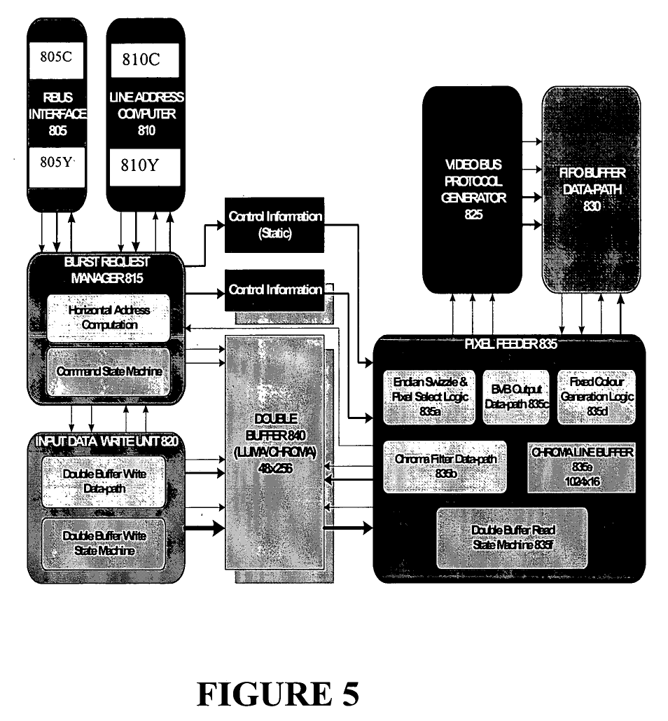

Referring now to FIG. 5, there is illustrated a block diagram of the feeder 715 in accordance with an embodiment of the present invention. The feeder 715 comprises an RBUS interface 805, a line address computer (LAC) 810, a Burst Request Manager (BRM) 815, an input data write unit (IDWU) 820, a buffer 840, a pixel feeder 835, a BVB protocol generator 825, and an output buffer 830.

The host processor 90 programs the feeder 715 during the VBI with the addresses in the frame buffer 48 storing the starting chroma and luma pixels of the frame. The starting addresses are provided to the feeder 715 via a luma starting address register 805Y and a chroma starting address register 805C in the RBUS interface 805. After providing the parameters to the RBUS interface 805, the host 90 sets a start parameter in the RBUS interface 805.

The feeder 715 fetches each pixel line in a series of bursts and stores the pixels in the buffer 840. The initial starting luma and chroma addresses are provided to the BRM 815. When the BRM 815 receives the starting luma and chroma addresses, the start parameter in the RBUS Interface 805 is deasserted.

The BRM 815 issues the commands for fetching the luma and chroma pixels in the first line of the frame/field. The IDWU 820 effectuates the, commands. The pixel feeder 835 retrieves the pixels from the buffer 840, and outputs a rasterized stream formatted in accordance with the display format. The output rasterized stream is provided to the output buffer, via the BVB protocol generator.

After the BRM 815 receives the starting addresses of the frame, the LAC 810 detects deassertion of the start parameter and calculates the starting address of the next line and stores the addresses in the RBUS Interface 805 and reasserts the start parameter. The starting addresses of the next line are determined by appropriately incrementing the starting address of the current line.

The LAC 810 includes a last luma line start register 810Y and a last chroma line start register 810C. Initially, the address write to the registers 805Y and 805C are transferred to the registers 810Y and 810C. The LAC 810 calculates the starting addresses for a line 100(x) by incrementing the registers 810Y and 810C. The registers 810Y, 810C then store the starting address for the line 100(x). To calculate the starting addresses for a line 100(x+1), the LAC 810 increments the registers 810Y and 810C.

When the BRM 815 and IDWU 820 finish transferring the current line to the buffer 840, the BRM 815 receives the starting addresses for the next line from the RBUS Interface 805. When the BRM 815 receives the starting addresses for the next line, the start parameter is deasserted. The foregoing process is repeated until the end of the picture.

The operation of the LAC 810 is described in greater detail in 60/495,695, that is incorporated herein by reference.

The RBUS Interface 805 is programmed with the starting addresses of the previous frame 100₀ following the previous Vsynch, Vsynch₀, in registers 805Y, 805C. Ideally, the RBUS Interface 805 receives starting addresses of frame 100₁ in registers 805Y, 805C before or during the VBI following Vsynch₁. Where the RBUS Interface 805 receives the starting addresses of frame 100₁ prior to a predetermined time, such as Hsynch₀ following Vsynch₁, the starting addresses of frame 100₁ overwrite the starting addresses of frame 100₀

If the addresses are not received, the feeder 715 may not be able to rasterize and provide the next frame, frame 100₁, for display. The foregoing can potentially result in a noticeable degradation of quality in the display of the video. However, the RBUS interface 805 maintains the starting addresses for the previous frame 100₀. To reduce the degradation in the quality of the display of the video caused by the foregoing, where the RBUS interface 805 does not receive the starting addresses for the next frame, e.g., 100₁ for display by a predetermined time, such as the first Hsynch₀ following Vsynch₁, the pixel feeder 715 rasterizes and provides the previous frame 100₀ for display during the display time (the time period between Vsynch, and the following Vsynch) for frame 100₁ . The feeder 715 rasterized the previous frame 100₀ based on the starting addresses programmed into the registers 805Y, 805C following Vsynch₀.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor can be implemented as part of an ASIC device with various functions implemented as firmware.

While the invention has been described with reference to certain embodiments, it will be understood by those skilled in the art that various changes may be made and equivalents may be substituted without departing from the scope of the invention. In addition, many modifications may be made to adapt particular situation or material to the teachings of the invention without departing from its scope. Therefore; it is intended that the invention not be limited to the particular embodiment(s) disclosed, but that the invention will include all embodiments falling within the scope of the appended claims.

1. A method for displaying frames, said method comprising:
providing a first frame;
waiting to receive information about a second frame to display, after displaying the first frame; and
providing the first frame, if the information regarding the second frame is not received before a predetermined time.

2. The method of claim 1, further comprising:
providing the second frame if the information regarding the second frame is received by the predetermined time.

3. The method of claim 1, wherein the predetermined time comprises a first horizontal synchronization pulse following a vertical synchronization pulse associated with the second frame.

4. The method of claim 1, wherein the information comprises an address of a memory location, wherein the memory location at the address stores a starting pixel for the second frame.

5. The method of claim 1, further comprising:
receiving information regarding the first frame; and
storing the information regarding the first frame.

6. The method of claim 5, wherein providing the first frame if the information regarding the second frame is not received before the predetermined time further comprises providing the first frame based on the information regarding the first frame, and wherein the method further comprises:
overwriting the information regarding the first frame with the information regarding the second frame and providing the second frame based on the information regarding the second frame, if the information regarding the second frame is received before the predetermined time.

7. The method of claim 1, wherein providing the first frame further comprises:
rasterizing the first frame.

8. A system for displaying frames, said system comprising:
a display engine for providing a first frame;
a host processor for providing information about a second frame to the display engine, after the display engine provides the first frame; and
wherein the display engine provides the first frame, if host processor does not provide the information regarding the second frame to the display engine before a predetermined time.

9. The system of claim 8, wherein the display engine provides the second frame if the host processor provides the information regarding the second frame before the predetermined time.

10. The system of claim 8, wherein the predetermined time comprises a first horizontal synchronization pulse following a vertical synchronization pulse associated with the second frame.

11. The system of claim 8, further comprising:
a frame buffer for storing the second frame beginning at least one starting address; and
wherein the information comprises the at least one starting address.

12. The system of claim 8, further comprising:
a first at least one register for storing the information regarding the first frame.

13. The system of claim 12, further comprising:
a feeder for providing the first frame based on the information regarding the first frame if the host processor does not provide the information regarding the second frame before the predetermined time.

14. The system of claim 13, wherein the host processor overwrites the information regarding the first frame with the information regarding the second frame and wherein the feeder providing the second frame based on the information regarding the second frame.

15. The system of claim 13, wherein the feeder rasterizes the first frame.

16. A feeder for providing a frame, said feeder comprising:
a first one or more registers for storing one or more starting address for a first frame;
a circuit for calculating starting addresses for one or more rows of the first frame following a vertical synchronization pulse associated with the first frame;
a host processor for writing one or more starting address for a second frame to the first one or more registers; and
wherein the first one or more registers stores the one or more starting address for the first frame until the host processor writes the one or more starting address for the second frame to the first one or more registers.

17. The feeder of claim 16, further comprising:
a second one or more registers for storing the starting addresses for one or more rows of the first frame, following the vertical synchronization pulse associated with the first frame; and
wherein the circuit for calculating the starting address for one or more rows increments the starting address stored in the second one or more registers.

18. The feeder of claim 17, wherein the second one or more registers stores the starting addresses for one or more rows of the second frame following a vertical synchronization pulse associated with the second frame, and wherein the circuit calculates the starting address for one or more rows of the second frame following the vertical synchronization pulse associated with the second frame, if the host processor writes the one or more starting address to the first one or more registers before a predetermined time.

19. The feeder of claim 17, wherein the second one or more registers stores the starting address for one or more rows of the first frame following a vertical synchronization pulse associated with the second frame, and wherein the circuit calculates the starting address for one or more rows of the first frame following the vertical synchronization pulse associated with the second frame, if the host processor does not write the one or more starting address to the first one or more registers before the predetermined time.

20. The feeder of claim 19, wherein the predetermined time is at a first horizontal synchronization pulse following the vertical synchronization pulse associated with the second frame.
